(19) United States
(12) Patent Application Publication
(10) Pub. No.: US 2003/0162017 A1
(43) Pub. Date: Aug. 28, 2003

(54) Composite tape construction and method

(76) Inventors: Matthew G. Weir, Spartanburg, SC (US); Paul A. Rundquist, Inman, SC (US)

Correspondence Address: Milliken & Company, P.O. Box 1927, Spartanburg, SC, 29304, US

(21) Appl. No.: 09/961,631

(22) Filed: Sep. 24, 2001

(51) Int. Cl. B32B 7/12; B32B 15/04; B32B 31/20

(52) U.S. Cl. 428/354; 428/343; 428/356; 156/324; 156/308.2

(57) ABSTRACT

A composite tape substrate, formed by at least two polymers, where the polymer on the face side has a relatively low peel strength in combination with the adhesive, and where the polymer on the backside has a relatively high peel strength in combination with the adhesive.

### BACKGROUND OF THE INVENTION

The present invention relates to pressure sensitive tape constructions and methods for manufacturing such tape constructions. More specifically, the present invention relates to a composite tape substrate, formed by at least two polymers, where the polymer on the face side has a relatively low peel strength in combination with the adhesive, and where the polymer on the backside has a relatively high peel strength in combination with the adhesive.

Heretofore, various methods and constructions have been proposed in order to provide a tape substrate that has a strong adhesive bond on a backside, to facilitate application to other surfaces, and which also has a weak adhesive bond on a face side thereof, so that the tape may be easily unrolled. Tape substrates have been manufactured so that the substrate itself inherently forms a weak bond with the adhesive. This construction requires a primer coating, which allows the adhesive to stick to the backside of the substrate. In this arrangement, the two required features are present: releasability on the face side, which is derived from the choice of substrate, and the strong adhesion on the backside, which is added in the form of a primer coating.

Conversely, other tape substrates have been manufactured so that the substrate itself inherently forms a strong bond with the adhesive. In this case, a release coating must be applied to a face side of the substrate, in order to facilitate releasability. The disadvantage of using a release coating to the face side is that some of the coating transfers to the adhesive, and weakens the adhesive when the tape is applied to another surface.

Attempts have been made to include a release agent within the substrate itself, and the release agent is usually an additive that blooms to the surface of the substrate. No suitable method has been found to force the release agent to migrate to a surface of the substrate without the release migrating to the adhesive as well. Further, both release coatings and primer coats add cost and complexity to the tape substrates, as well as to the manufacturing process.

Thus, it would be desirable to provide a tape construction that would allow the face side to have a relatively low peel strength for releasability, while retaining a relatively high peel strength for strong adhesion to other surfaces, without the necessity of using primer coatings or release coatings or agents. Further, it would be desirable to provide a method for manufacturing such a tape substrate.

Practical adhesion can be thought of as the failing load for a joint due to either environmental or mechanical stresses holding two different bodies together. The adhesive is the material employed to accomplish the joining. The effectiveness of an adhesive is usually determined by, for example, monitoring the average load required for the joint to fail under specified conditions, and is not necessarily an equilibrium process. It is important to note that real joint failure will occur under stresses that are a fraction of the theoretical work of adhesion established by thermodynamic arguments, indicating that real joint failure is determined by both equilibrium and non-equilibrium processes.

Good joint formation requires that the adhesive be intimately in contact with the surfaces it is joining. That is, the adhesive should completely wet the surface minimizing surface voids that might result in stress concentration and, hence, a weakening of the joint. For this reason, adhesives are typically fluid during formation of the bond, and are formulated such that upon drying, curing, and in use they neither result in the formation of weak boundary layers, nor due they create interfacial stress that will result in a weakening of the joint.

Wetting of the surfaces to be bonded by the adhesive is driven by the respective solid and liquid surface energies, and is a decidedly thermodynamic process. The surface energy is the free energy increase per unit increase in surface area at constant temperature and pressure at equilibrium. The surface energy arises from the fact that molecules at the surface are subjected to unbalanced intermolecular interactions due to the presence of the interface as compared with the bulk. When additional surface area is created, molecules must migrate from the bulk to the surface to minimize the total free energy of the system. Since more interactions in the bulk must be disrupted than will be reformed at the interface, work must be done to move bulk molecules to the surface and the total free energy of the system is increased by an amount proportional to the increased surface area. Therefore, the system resists the increase in surface area, and the net result is an apparent contractile force per unit length (the surface tension) that has the effect of minimizing the surface area of a liquid. Surface energies for pure liquids are characteristic of the material, and standard methods are available for their determination.

Unambiguously evaluating the surface tension for solids is more complicated than for liquids, and is still the subject of great controversy. In particular, when additional surface area is created for a solid, bulk molecules are not free to diffuse to the surface to minimize the overall energy of the system over reasonable timescales. Directly determining the surface energy of the solid at equilibrium is therefore extremely difficult. Indirect methods result in surface energy values strongly dependent on the method and/or standards used. Various techniques for directly and indirectly evaluating surface energies of solids, including polymer surfaces, are described in detail in B. W. Cherry, Polymer Surfaces, (Cambridge, N.Y., 1981). High viscosity fluids, such as the commonly used adhesives at room temperature, suffer from the same difficulties as solids.

Common experience shows that in many instances when a liquid is placed on a solid a drop results that has a characteristic angle measured at the solid/liquid/vapor contact point from the solid surface through the liquid and tangent to the liquid/vapor interface. The thermodynamic relationship, the Young-Dupre equation, which establishes the connection between contact angle and the surface energies of the solid and liquid are well-known and may be found in any standard surface chemistry text such as A. W. Adamson, Physical Chemistry of Surfaces, Fifth Edition, (Wiley Interscience, NY, 1990). In practical situations, a liquid is said to completely wet a surface if the measured contact angle is zero while for a contact angle greater than 90° the liquid is said to be non-wetting of that surface. Contact angle for a fluid on a solid is an experimentally measurable quantity and is strongly influenced by the chemical and physical nature of the solid surface, as is described by Adamson. In particular, surface roughness has a significant impact on wetting, and can either help or hurt depending on the size of the features and the relative surface energies of the solid and the liquid. Impurities on the surface will also exhibit a significant impact on wetting. In commercially viable extrusion coating of a fabric scrim, molecularly smooth and impurity-free surfaces are not possible, nor would it be cost effective to run the coated fabric through post-coating processes to improve adhesion through cleaning and/or improving the surface topography.

Many empirical and semi-empirical methods have been developed to use contact angle measurements to estimate the surface energies of solids. One of the more useful methods is that due to Zisman (described in detail in both Cherry and Adamson) in which the cosine of the contact angle is plotted against the surface energy for a homologous series of standard fluids. The surface energy value obtained when the plot is extrapolated to zero contact angle is termed the “critical surface tension”, and is commonly assigned to be the surface energy of the solid. However, as Kitizaki and Hata clearly point out [Y. Kitazaki and T. Hata, in Recent Advances in Adhesion, Lieng-Huang Lee, ed., (Gordon and Breach, NY, 1973), pgs. 65-76], the value for the critical surface tension of a solid is strongly dependent on the choice of liquid standards used. In particular, they associate the differences to the relative importance of polar (and hydrogen bonding) interactions versus dispersive interactions between the liquid molecules and the solid surface. These authors show that contact angles for surfaces using water as a pure liquid are systematically related to the critical surface tensions of these solids established using a series of polar, hydrogen bonding fluids whereas no such relationship exists if purely dispersive fluids are used to establish the critical surface tensions. They go on to show that for a more polar epoxy adhesive, there is a strong relationship between the measured tensile shear strength of joints and the critical surface tensions established using the polar liquid series. Thus, in this case one expects to observe a strong correlation between the contact angle determined for water on these surfaces and the joint strength between the surface and the adhesive. This result suggests a simple way of screening potential candidate surfaces for use in tape applications merely by measuring the contact angle of a single standard liquid on the surface if the correlation can be established between joint strength with the adhesive of choice and the measured contact angle can be established. This approach is particularly desirable for polymer surfaces for which it might be difficult to obtain multiple fluids that will not swell the polymer during the contact angle measurement. All articles cited are incorporated herein by reference.

Wetting is desirable in order to obtain good adhesion between a liquid and a solid, and the surface energy of the wetting fluid should be equal to or less than the critical surface tension of the solid for complete wetting to occur. This holds true whether the liquid is a molten polymer fluid, an adhesive, or a low molecular weight liquid. In designing a composite tape substrate designed to have poor face adhesion, yet strong backside adhesion to the chosen adhesive mass, both material selection and the process of preparation are important.

### OBJECTS OF THE PRESENT INVENTION

Accordingly, one aspect of the present invention is to provide a tape construction having a relatively high peel strength on one side, and a relatively low peel strength on the other, without the use of primer coats or release agents or coatings.

Another aspect of the present invention is to provide a composite tape substrate made from two polymeric layers (face side and backside), where the polymers may be adhered together without the use of a tie layer to bond the back and face sides together.

Still another aspect of the present invention is to provide a composite tape substrate made from different polymers, where the substrate is not prone to curling.

Yet another aspect of the present invention is to provide a method for manufacturing a tape substrate having a relatively high peel strength on one side, and a relatively low peel strength on the other, without the use of primer coats or release agents or coatings.

Another aspect of the present invention is to provide a tape construction and method that reduces or eliminates the formation of shiny spots on a face side thereof, which is an undesirable aesthetic effect.

Yet another aspect of the present invention is to provide a tape substrate that overcomes some of the shortcomings of other tape substrates, and which may be manufactured in an inexpensive, cost effective manner.

### BRIEF DESCRIPTION OF THE DRAWINGS

These and other features, aspects, and advantages of the present invention will become better understood with regard to the following description, appended claims, and accompanying drawings where:

FIG. 1 is a cross-sectional view of a composite tape substrate and construction, showing a face side polymeric layer, a textile or fabric layer, a backside polymeric layer and an adhesive layer; and

FIG. 2 is a cross-sectional view of an alternative embodiment of a composite tape substrate and construction, showing a face side polymeric layer directly attached to a backside polymeric layer, and an adhesive layer.

### DESCRIPTION

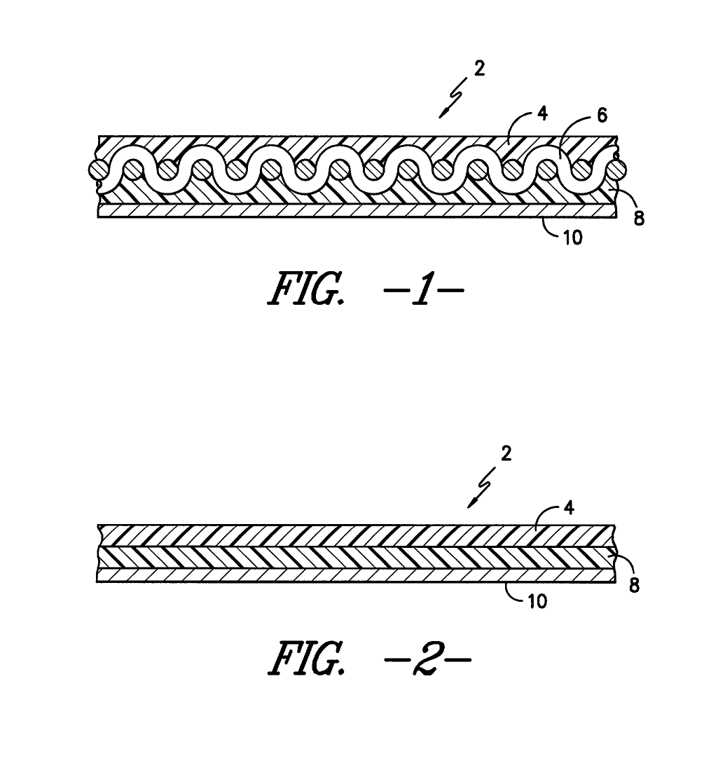

Referring to FIG. 1, a pressure sensitive tape construction is disclosed, wherein the tape substrate 2 includes a face side polymeric layer 4, a textile or fabric layer 6, a backside polymeric layer 8, and an adhesive layer 10 adhered thereto. In a preferred embodiment, the face side polymeric layer should be chosen from the group consisting of: silicone grafted polyethylene, poly tetrafluoroethylene (Teflon), fluoronated polyolefins, chloronated polyolefins, polyethylene (including low density, high density, linear low density, medium density, metallocene catalyzed), polypropylene, epdm rubber, polyvinyl stearyl carbamate, poly chloro trifluoroetylene (Aclar), polystyrene, and polyvinyl chloride. Other suitable alternative polymers may be used for the face side layer, but should have a surface energy lower than the surface energy of the adhesive to ensure poor wetting of the adhesive onto the polymer surface, and hence poor adhesion.

The textile or fabric layer, in a preferred embodiment, is a knit fabric, which is much less expensive than the typical woven substrates found in tape constructions. More preferably, the fabric is a weft inserted warp knit fabric. The textile layer is encapsulated between the polymeric layers, which tends to hold the yarns in place and allows easy and straight tearing in the warp or machine direction, as well as in the weft direction.

The backside polymeric layer, in a preferred embodiment, should be chosen from the group consisting of: nylon (including nylon 6, nylon 6,6, nylon 11, nylon 2, nylon 12), polyurethane (aliphatic: polyether or polyester, aromatic: polyether or polyester), polyvinylidene chloride, polyethylene terephthalate and copolymers of the same, polybutylene terephthalate and copolymers of the same, poly trimethylene terephthalate and copolymers of the same, copolymers of polyethylene (including ionomers, ethylene acrylic acid, ethylene methyl acrylate, ethylene vinyl acetate, ethylene n-butyl acrylate), polyacrylonitrile, polymethylmethacrylate, polycarbonate, polysulfone, and cellophane. Other suitable alternative polymers may be used for the backside layer, but should have a relatively higher surface energy than that of the face polymer and the adhesive.

FIG. 2 shows an alternative embodiment, wherein the face side polymeric layer is directly attached to the backside polymeric layer, without a fabric layer positioned therebetween.

The adhesive layer, in a preferred embodiment, should be chosen from the group consisting of rubber based adhesives (both natural and synthetic), acrylic based adhesives, silicone based adhesives and polyurethane based adhesives. Of course, other suitable adhesives may be used, and a preferred adhesive will exhibit a lower surface energy that that of the surface energy of the backside polymer.

The polymers are chosen such that the face side of the composite is inherently releasing to the adhesive chosen, thus exhibiting low peel strength. The backside polymer is chosen to have the higher surface energy of the two polymers, and also with respect to the adhesive, in order to obtain good wetting/adhesion with the adhesive and the face polymer. Typically, the backside polymer will be chosen from a group of functionalized polymers considered to be tie resins for the face polymer. One advantage to this approach is that applying a release coating in a separate step on the face polymer is not necessary, thus providing a cost savings. Further, it is not necessary to apply a separate tie layer or primer between the face and backside polymer layers to ensure adequate composite strength.

For pressure sensitive adhesive tapes, in order for adhesive to stick to the backing it must wet the backing by providing maximum surface contact therewith. One way of ensuring wetting is to use a substrate with a critical surface tension greater that the surface energy of the adhesive. The critical surface tension for a solid is defined as—the surface energy a low molecular weight liquid must have for the contact angle with the solid to be exactly zero and hence spontaneously and completely wet out the surface. Slight roughening or oxidation of the surface (via corona treatment, for example) of the surface will tend to reduce the contact angle, if the initial contact angle between the liquid and solid is less than 90 degrees. In addition, with a rough surface, the receding contact angle is always lower than the advancing contact angle, so it is possible to force the adhesive mass to wet out the surface (even if its advancing contact angle is greater than zero) by doing work on it, and if the system is chosen correctly, the receding contact angle will be zero.

Wetting alone is not theoretically sufficient for optimal adhesion. It is known that the work of adhesion can be split up into component contributions, so it is also possible to split the surface energy up into component contributions. The most common approach is to split surface energy into dispersive and polar contributions. The theory is that where a liquid completely wets a surface, the optimum adhesion is achieved when the polar component of the liquid surface energy matches the polar component of the solid surface energy. Ultimately, therefore, it is desirable to be able to identify polymer materials that are suitable for use as the back side layer of a tape backing with a particular adhesive on the basis of comparing total surface energy and the polar components of the surface energies for the solid and the adhesive. Selection of the face side polymer is also done on the basis of comparison of surface energies, but with the goal of trying to mismatch as much as possible (with the adhesive surface energy being greater) to ensure poor wetting. The goal, therefore, is to provide an adhesive having a first surface energy, and apply the adhesive to a backside polymeric layer having a second surface energy that is significantly higher than the first surface energy, thus forming a strong bond between the backside and adhesive. Then a face side polymeric layer having a third surface energy that is lower than the first surface energy is joined to the backside polymeric layer (on the opposite side from the adhesive), thus providing releasability between the face side polymeric layer and the adhesive when the tape is in a rolled up state. Ideally, the composite substrate will have face and backside materials that are compatible enough with each other to form a sufficiently strong interface therebetween, while behaving in opposite manners when interacting with the adhesive mass. Given the difficulties of establishing unambiguously the surface energies of solids and high viscosity fluids, a relative means of comparison of various substances is satisfactory.

In the manufacturing process, it is preferable that the backside polymer, having the higher surface energy material, be applied to the scrim or textile component first in order to maximize composite strength. The low surface energy face polymer tends to wet out high surface energy backside layer polymeric material more completely than the face side polymeric material, and wetting facilitates strong adhesive bonding. A second reason is that the application of the backside polymer first to the scrim will minimize the formation of unsightly dimples on the face side caused by air entrapment during face coating due to the three-dimensional nature of the fabric scrim. Dimples in the face side are unacceptable aesthetic qualities in certain applications such as gaffer's tape, where the smooth curved surface of the dimples appears as shiny spots against the matte black background of the rest of the surface.

Because the structure of the composite is unbalanced, it will have a tendency to curl rather than lay flat. Subsequent processing of the tape composite, such as applying the adhesive and slitting, will be complicated if the substrate has a tendency to curl. Therefore, it is preferable that the coating weights (or thicknesses) of the two polymer layers in an unbalanced structure be chosen to minimize curl.

Testing and Experimental Results

The tables below include results of experimentation showing statistically significant trends illustrating the correlation between peel adhesion and measured contact angle using distilled water as the standard fluid, which is directly related to the polymer surface energy.

1. Film Contact Angle Measurement

Film contact angle measurements can provide data that may be directly correlated with relative surface energy. Commonly, multiple fluids with different polar and dispersive components of the surface energy are employed to arrive at an estimate for the solid surface energy, but since the choice of fluids affects the outcome, this approach is not without ambiguity. Measuring contact angle of a single standard fluid for a variety of solids provides a relative ranking of wetting of the solids in question provided that the standard fluid used is representative of the class of fluids of interest. The contact angle using water on each film was correlated with the adhesive joint failure between an adhesive and the polymeric film.

| | |
|---|---|
| Procedure: | A sample was cut from a prepared strip of polymeric film |
| | of the dimensions 1″ by 1″. The film was mounted onto an |
| | apparatus designed to measure advancing/receding contact |
| | angle. If the film sample exhibited curl, a butterfly shaped |
| | clip was used to hold the film straight as it enters the liquid. |
| Equipment: | Krüss Wilhelmy Balance |
| Results: | Each film was tested for advancing/receding contact angle |
| | using three (3) independent samples, and the average |
| | value determined by averaging the angles for the three |
| | independent measurements. Distilled water was used as the |
| | test fluid for all films, with a measured surface tension |
| | of 72 dyn/cm using a flamed platinum plate in the same |
| | instrument. The film samples themselves were carefully |
| | handled so as to avoid contamination, but they were not |
| | cleaned in any way prior to measurement. Reproducibility |
| | among the three samples was generally very good. The |
| | advancing contact angle was calculated based on the force |
| | required to push the film into water and on the perimeter |
| | of the film sample. Likewise, the receding contact angle |
| | was calculated based on the force required to remove the |
| | film from the water and on the perimeter of the film |
| | sample. The contact angle and peel adhesion (vide infra) |
| | data were plotted, and standard linear regression used to |
| | calculate a correlation coefficient. |

Test Results:

Contact Angle Measurements

| | Average Advancing |
|---|---|
| Polymer | Contact Angle (°) |
| PTT | 81.6 |
| Ethylene Vinyl Alcohol | 85.9 |
| Nylon Copolymer | 94.4 |
| Nylon | 95.1 |
| Ethylene Vinyl Acetate | 98.0 |
| Ethylene Ethyl Acrylate/Acrylic Acid | 98.4 |
| Ethylene Methyl Acrylate | 98.7(1) |
| Ethylene Acrylic Acid | 99.0 |
| Ionomer | 99.3 |
| Poly Butylene Terephthalate Homopolymer | 99.5 |
| Linear Low Density Polyethylene | 99.9 |
| Anhydride Grafted Ethylene Vinyl Acetate | 102.4(1) |
| Poly Butylene Terephthalate Copolymer | 102.6 |
| Polypropylene | 103.4 |
| Metallocene Polyethylene | 104.1(1) |
| Low Density Polyethylene | 104.2 |
| Polypropylene Copolymer | 105.7 |
| Polyethylene Fluoropolymer | 106.5 |
| Silicone Grafted Polyethylene | 109.5 |

(1)These films were only tested at two (2) independent points

2. Dimples/Unit Area Measurement

Microscopy was used to count the number of dimples/unit area of a sample of coated fabric. We also correlated the number of dimples with various processing conditions used to create the samples.

| | |
|---|---|
| Procedure: | Cut an 8″ × 11″ piece from a prepared sample of coated |
| | fabric and place the sample under a light microscope. Using |
| | the microscope, enlarge a standard area of the surface of |
| | the sample (250×). Using the connected PC, count the |
| | number of dimples/unit area on the surface of the |
| | sample. Take the average of the number of dimples per |
| | unit area for each sample and compare the relative amount |
| | of dimples. |
| Equipment: | HiROX Light Microscope |
| | Model—MX-2010Z |
| | Connected to a PC to allow printouts of digital images |
| Results: | Each sample was tested for dimples at 15 independent |
| | points at a magnification of 250×. The number of dimples |
| | for each of the 19 samples was averaged to determine the |
| | number of dimples/unit area. A statistical model was built |
| | based on the data collected. |

Test Results:

Dimples Per Unit Area Measurement

| | “Face” | “Face” Coat | “Back” | Average |
|---|---|---|---|---|
| Sample | Melt | Thickness | Coat Thickness | Dimples/ |
| Number | Temp. (° F.) | (mils) | (mils) | Area |
| 1 | 562.5 | 3 | 1.75 | 0.2 |
| 2 | 525 | 1 | 0.75 | 34.4 |
| 3 | 525 | 1 | 2.75 | 34.6 |
| 4 | 525 | 3 | 1.75 | 0.4 |
| 5 | 525 | 5 | 0.75 | 2.4 |
| 6 | 525 | 5 | 2.75 | 0.0 |
| 7 | 562.5 | 3 | 1.75 | 1.1 |
| 8 | 562.5 | 1 | 1.75 | 34.7 |
| 9 | 562.5 | 3 | 0.75 | 8.7 |
| 10 | 562.5 | 3 | 1.75 | 0.3 |
| 11 | 562.5 | 3 | 2.75 | 0.5 |
| 12 | 562.5 | 5 | 1.75 | 0.1 |
| 13 | 562.5 | 3 | 1.75 | (1) |
| 14 | 600 | 1 | 0.75 | 36.9 |
| 15 | 600 | 1 | 2.75 | 35.5 |
| 16 | 600 | 3 | 1.75 | 0.7 |
| 17 | 600 | 5 | 0.75 | 10.7 |
| 18 | 600 | 5 | 2.75 | 0.0 |
| 19 | 562.5 | 3 | 1.75 | 0.4 |

(1)Not determined.

3. Handle-O-Meter Test Measurement

Stiffness of a coated tape base substrate was correlated with peel adhesion of an adhesive to that substrate. This correlation was shown by the relative measure of Handle-O-Meter stiffness.

| | |
|---|---|
| Procedure: | A 4″ × 4″ piece was cut from a prepared sample of |
| | coated fabric and the sample was placed on the Handle-O- |
| | Meter stiffness-testing device. The device then forced the |
| | sample through a slot using standard conditions. The |
| | result of this test is the force in grams that it takes |
| | to force the sample through a standard opening in the |
| | machine. The standard opening used was 5 mm. Teflon |
| | coated testing pieces were used to minimize the effect |
| | of surface roughness on the measurements. Handle-O-Meter |
| | testing is covered under ASTM standard D2923-15 |
| | Standard Test Method for Rigidity of Polyolefin Film |
| | and Sheeting. |
| Equipment: | Thwing Albert Instrument Co. |
| | Handle-O-Meter Tester: Model—211-300 |
| Results: | Each sample was tested independently three (3) times |
| | under standard testing conditions. The three data points for |
| | all samples were averaged and a statistical model was built |
| | based on the data collected. |

Test Results:

Handle-O-Meter Stiffness Testing

| | Average | |
|---|---|---|
| | MD | Average |
| | Stiffness | CD |
| Polymer | (g) | Stiffness (g) |
| Ethylene Methyl Acrylate | 2 | 4 |
| Ethylene Ethyl Acrylate/Acrylic Acid | 6 | 3 |
| Metallocene Polyethylene | 6 | 10 |
| Ethylene Acrylic Acid | 10 | 10 |
| Anhydride Grafted Ethylene Vinyl Acetate | 10 | 10 |
| Ethylene Vinyl Acetate | 15 | 14 |
| Polypropylene Copolymer | 15 | 11 |
| Silicone Grafted Polyethylene | 15 | 16 |
| Polyethylene Fluoropolymer | 21 | 18 |
| Low Density Polyethylene | 22 | 22 |
| Linear Low Density Polyethylene | 25 | 30 |
| Ionomer | 28 | 26 |
| Etyelene Vinyl Alcohol | 54 | 65 |
| Nylon Copolymer | 59 | 49 |
| Poly Butylene Terephthalate Copolymer | 78 | 128 |
| Poly Butylene Terephthalate Homopolymer | 103 | 84 |
| Polypropylene | 124 | 118 |
| Nylon | 281 | 254 |
| PTT | (1) | (1) |

(1) Did not perform the test on this material

### EXAMPLE 1

Example 1 illustrates that different polymers are useful in constructing composite substrates in the present invention.

Various polymers were cast into approximately 3 mil (75 micron) films. Films were cast using a 1 in. (25 mm) Killion single screw extruder (available from Davis-Standard Corp., of Pawcatuck, Conn.) equipped with an 8 in. (203 mm) coat hanger, slot die and a modified Killion film take-up system. The melt temperatures of the polymers varied from 450° F. to 525° F. After the film was extruded, the polymer was quenched on a water-cooled roll. It is important to cast the film onto the chill roll in such a way that the polymer has a maximum amount of contact time with the chill roll so that it will quench properly. The temperature of the chilled roll was 21° C. Care was taken to avoid excess handling of the film samples as they were used in subsequent testing with further preparation to simulate real world experience.

Once the film had started casting, time was allowed to ensure that the film was of uniform thickness. Depending on the size of extruder used a time of 2 to 10 minutes should be sufficient. Once a uniform thickness was reached, two pieces of film of approximately 4 ft. in length were collected for each polymer. The pieces of film were collected before the film was wound onto a take-up roll to keep the film from crinkling and sticking to itself. This is important with respect to measurement of contact angle due to the error associated with non-uniform surfaces. Also, pieces of paper towel were placed between each individual sample to ensure that no samples stuck to one another. A list of the polymers that were prepared can be found in Table I.

Independent pieces of each film were tested for peel strength relative to a commercially available adhesive tape and were tested for contact angle in water. The peel adhesion testing was performed using a tensile testing machine. First, the films were cut into 3 in. by 7 in. strips and placed on a standard stainless steel testing plate available from ChemInstruments of Fairfield, Ohio. The films were attached to a plate using a commercially available double-sided adhesive tape. Care should be taken when applying the films to the steel plates so as not to trap air under the film. A standard 4.5 lb. rubber covered roller was used to apply the films to the steel plates.

Next, an acrylic-based adhesive tape Grade OAKC 488 (available from Tyco Adhesives of Norwood, Mass.) was applied to the film face using a standard 4.5 lb. rubber covered steel roller that meets PSTC standards for testing equipment. The roller was passed over the tape with three forward and three reverse passes at a rate of about 6 in/sec. At one end of the tape, a loop was made and the tape was adhered to itself to allow for a place for the jaws of the tensile tester to hold the tape. The entire sample was then placed into an MTS Q-Test 25 tensile testing machine (available from MTS Systems Corp. of Research Triangle Park, N.C.). One end of the steel plate was placed in the lower jaws of the tensile tester and the looped end of the tape was placed in the upper jaws of the tensile tester so that the tape was peeling off the substrate at a 180° angle. Each sample was tested within one minute of the application of the adhesive tape. The adhesive tape was pulled at a constant rate of 12 in/min. Table I lists the peel test measurements with acrylic adhesive tape for the twenty samples.

Contact angle with distilled water (with a measured surface tension of 73.2 dynes/cm) was performed to establish the correlation with peel adhesion. Simplistically, the more hydrophobic the polymer surface (i.e. lower surface energy) the higher the contact angle when water is used as the standard fluid. The more hydrophilic the polymer surface (i.e. higher surface energy) the lower the contact angle when water is used as the standard fluid. Table I lists the peel strength and contact angle with water of the different polymers tested. Due to the effect of surface roughness and impurities on receding contact angle, only advancing angle was considered.

The contact angle measurement was performed by the following technique, cut a sample from a prepared strip of polymeric film of the approximate dimensions 1 in. by in. Mount the film onto a Wilhelmy balance available from Krüss GmbH of Hamburg Germany. A butterfly shaped clip was used to hold the film straight as it entered the liquid. The exact dimensions of the film piece were input into a computer program that is designed to automate the contact angle measurement. Each film was tested for advancing/receding contact angle using three (3) independent samples.

TABLE I

| | | | | Mean Peel Strength, |
|---|---|---|---|---|
| | | | | Std. Tape from |
| Sample | | | Mean Advancing | Polymer film (N/25 |
| Number | Polymer Trade Name | Polymer Type | Contact Angle (°) | mm) |
| 1 | ExxonMobil LD 202 | Polyethylene | 104.2 | 4.0 |
| 2 | Dow Corning MB50-002 | Modified | 107.8 | 0.8 |
| | | Polyethylene | | |
| 3 | Exxon Exxact 3040 | Metallocene | 104.1(i) | 4.2 |
| | | Polyethylene | | |
| 4 | Ticona Riteflex 663 | Polybutylene | 102.6 | 4.8 |
| | | Terephthalate | | |
| | | Copolymer | | |
| 5 | BASF Ultramide B-3 | Nylon | 95.1 | 7.2 |
| 6 | Exxon Escorene 3155 | Polypropylene | 103.4 | 9.3 |
| 7 | Shell Corterra CP509201 | Poly | 81.6 | 17.0 |
| | | Trimethylene | | |
| | | Terephthalate | | |
| 8 | DuPont Surlyn 1652-1 | Polyethylene | 99.3 | 5.7 |
| | | Copolymer | | |
| 9 | Ticona Celanex 1400A | Polybutylene | 99.5 | 10.3 |
| | | Terephthalate | | |
| | | Homopolymer | | |
| 10 | DuPont Bynel 2022 | Polyethylene | 102.4(1) | 5.4 |
| | | Terpolymer | | |
| 11 | EMS Griltex 1330A | Nylon | 94.4 | 9.0 |
| | | Copolymer | | |
| 12 | Soarus Soarnol BG 3522 | Polyethylene | 85.9 | 11.5 |
| | | Copolymer | | |
| 13 | DuPont Elvax 3200 | Polyethylene | 98.0 | 4.3 |
| | | Copolymer | | |
| 14 | Dow Primacor 3460 | Polyethylene | 99.0 | 6.6 |
| | | Copolymer | | |
| 15 | Exxon Optema TC-220 | Polyethylene | 98.7(i) | 4.9 |
| | | Copolymer | | |
| 16 | Dow Dowlex 3010 | Polyethylene | 99.9 | 5.1 |
| 17 | Modern Dispersions Inc. PA-303V | Modified | 106.5 | 1.8 |
| | | Polyethylene | | |
| 18 | Exxon Escor AT-320 | Polyethylene | 98.4 | 4.4 |
| | | Terpolymer | | |
| 19 | Optatech Lubotene RLF-4009 | Modified | 109.5 | 1.5 |
| | | Polyethylene | | |
| 20 | Rexene Rexflex KS084 | Modified | 105.7 | 7.8 |
| | | Polypropylene | | |

(i)These films were tested at two (2) independent points.

In summary, trends show that as the advancing contact angle for water of the polymer film increases (i.e. lower surface energy) the mean peel strength decreases.

The same procedure was followed to apply a rubber-based adhesive tape Scotch 471 (available from 3M Co. of St. Paul, Minn.) to each of the twenty samples in order to perform 180° peel test measurements. The results of the peel test with the rubber-based adhesive tape are documented in Table II.

TABLE II

| | | | | Mean Peel Strength, |
|---|---|---|---|---|
| | | | | Std. Tape from |
| Sample | | | Mean Advancing | Polymer Film (N/25 |
| Number | Polymer Trade Name | Polymer Type | Contact Angle (°) | mm) |
| 1 | ExxonMobil LD 202 | Polyethylene | 104.2 | 1.9 |
| 2 | Dow Corning MB50-002 | Modified | 107.8 | 0.8 |
| | | Polyethylene | | |
| 3 | Exxon Exxact 3040 | Metallocene | 104.1(I) | 1.7 |
| | | Polyethylene | | |
| 4 | Ticona Riteflex 663 | Polybutylene | 102.6 | 1.7 |
| | | Terephthalate | | |
| | | Copolymer | | |
| 5 | BASF Ultramide B-3 | Nylon | 95.1 | 3.0 |
| 6 | Exxon Escorene 3155 | Polypropylene | 103.4 | 3.6 |
| 7 | Shell Corterra CP509201 | Poly | 81.6 | 5.5 |
| | | Trimethylene | | |
| | | Terephthalate | | |
| 8 | DuPont Surlyn 1652-1 | Polyethylene | 99.3 | 2.3 |
| | | Copolymer | | |
| 9 | Ticona Celanex 1400A | Polybutylene | 99.5 | 4.1 |
| | | Terephthalate | | |
| | | Homopolymer | | |
| 10 | DuPont Bynel 2022 | Polyethylene | 102.4(i) | 2.4 |
| | | Terpolymer | | |
| 11 | EMS Griltex 1330A | Nylon | 94.4 | 3.4 |
| | | Copolymer | | |
| 12 | Soarus Soarnol BG 3522 | Polyethylene | 85.9 | 4.1 |
| | | Copolymer | | |
| 13 | DuPont Elvax 3200 | Polyethylene | 98.0 | 2.4 |
| | | Copolymer | | |
| 14 | Dow Primacor 3460 | Polyethylene | 99.0 | 2.9 |
| | | Copolymer | | |
| 15 | Exxon Optema TC-220 | Polyethylene | 98.7(1) | 2.1 |
| | | Copolymer | | |
| 16 | Dow Dowlex 3010 | Polyethylene | 99.9 | 2.0 |
| 17 | Modern Dispersions Inc. PA-303V | Modified | 106.5 | 0.6 |
| | | Polyethylene | | |
| 18 | Exxon Escor AT-320 | Polyethylene | 98.4 | 2.2 |
| | | Terpolymer | | |
| 19 | Optatech Lubotene RLF-4009 | Modified | 109.5 | 1.4 |
| | | Polyethylene | | |
| 20 | Rexene Rexflex KS084 | Modified | 105.7 | 3.3 |
| | | Polypropylene | | |

(i)These films were tested at two (2) independent points.

Again, the trends show that as the advancing contact angle for water of the polymer film increases (i.e. lower surface energy) the mean peel strength decreases. As expected, the correlation is not as good as for the acrylic adhesive, suggestion that water is not the ideal standard fluid to use for non-polar rubber based adhesives.

### EXAMPLE 2

Example 2 illustrates that various dissimilar polymers can be combined in ways that yield high levels of internal bond strength that is useful in the present invention.

A film having a thickness of approximately 3 mils (75 microns) was prepared using an ionomer, specifically Surlyn 1652-1 obtained from DuPont of Wilmington, Del. The ionomer had a melt flow index of 4.5 dg/min, a density of 0.940 g/cm³, a vicat softening point of 174° F. and Zinc ions used for neutralization. Another film having a thickness of approximately 3 mils (75 microns) was prepared using low-density polyethylene, specifically Escorene LD 202 obtained from ExxonMobil Chemical, of Houston, Tex. The polyethylene has a melt flow index of 12 dg/min, a density of 0.915 g/cm³ and a peak melting temperature of 219° F. Each film was produced using the procedure documented in Example 1.

These films were heat pressed together using a Sencorp heat-seal press (Model Number-12-ASL/1, obtained from Sencorp Systems Inc. of Hyannis, Mass.) at temperatures of 225° F., 275° F. and 325° F. for a total of three seconds at a pressure of 25 psig. Both the top and bottom jaws of the heat seal press were heated to the same temperature in each case. Pieces of film were die cut into 1 in. by 6 in. strips. Each strip was cut in half yielding 1 in. by 3 in. strips of ionomer and low-density polyethylene films. In the case of controls, two strips of the same material were pressed together with the heat-seal press. The strips were pressed together a total of 1.5 in. in length allowing the remainder of the length of the strips to be used as tabs with which to perform the T-Peel test. ASTM standard D 1876 (Test Method for Peel Resistance of Adhesives (T-Peel Test)) was used as a template for testing; however, adaptations to the test were made to better suit the materials under evaluation. The T-Peel test measurements were completed on each composite generated by combination of the two dissimilar films at each temperature using the procedure described above.

To perform the T-Peel test, the composite samples were placed into an MTS Q-Test 25 tensile testing machine (available from MTS Systems Corp. of Research Triangle Park, N.C.). The tab of LDPE film was placed into one of the jaws of the tensile tester and the tab of ionomer film was placed into the other jaw of the tensile tester. The films were then pulled apart at a constant rate of 12 in/min and a total distance of 1 in. A force (in pounds) to peel the films apart was recorded. Table III shows the peel test results for the dissimilar films and Table IV shows the peel test for the control.

TABLE III

| | | Average Peel |
|---|---|---|
| Composite | Temperature (° F.) | Strength (N/25 mm) |
| Ionomer/LDPE | 225 | 13.3 |
| Ionomer/LDPE | 275 | >9.1(ii) |
| Ionomer/LDPE | 325 | >14.7(i) |

(i)One of the films broke before the composite was peeled apart.
(ii)One of the films elongated significantly before the composite was peeled apart.

TABLE IV

| | | Average Peel |
|---|---|---|
| Composite | Temperature (° F.) | Strength (N/25 mm) |
| Ionomer/Ionomer | 225 | >19.6(I) |
| Ionomer/Ionomer | 275 | >18.7(ii) |
| Ionomer/Ionomer | 325 | 8.0 |
| LDPE/LDPE | 225 | >10.7(i) |
| LDPE/LDPE | 275 | >15.1(i) |
| LDPE/LDPE | 325 | >11.0(i) |

(i)One of the films broke before the composite was peeled apart.
(ii)One of the films elongated significantly before the composite was peeled apart.

The peel strength between the ionomer and the low-density polyethylene was comparable to the controls for both the ionomer and low-density polyethylene at all three temperatures.

In general the bond between the ionomer and low-density polyethylene is strong enough to remain intact even until the tensile strength of one of the films is reached. This fact demonstrates that the composite containing ionomer and low-density polyethylene has strong internal bond strength.

### EXAMPLE 3

Example 3 illustrates that various dissimilar polymers can be combined in ways that allow for both improved bond strength and improved release characteristics in a way that is useful in the present invention.

In order to produce an adhesive tape base which functions properly, the adhesive itself must stick better to the “back” side of the tape base substrate (the side to which the adhesive is applied) than it does to the “face” side of the tape base substrate (the side opposite the adhesive side).

It is important to note that some combinations of polymers may not easily be bonded to one another in a way that would be useful for tape base substrates. Some polymers are not compatible enough with one another to allow for a functional tape base. Pieces of the twenty films that were described in Example 2 were heat-sealed together using the same procedure as described in paragraph 3 of Example 2.

Optimally, a tape base substrate would be constructed in such a way that the “back” polymer would have a higher bond strength to the adhesive of choice and the “face” polymer would have a lower bond to the adhesive of choice. However, a polymer with high bond strength to the chosen adhesive and a polymer with low bond strength to the chosen adhesive cannot be chosen at random. Table V contains the measurements of the T-Peel strengths of combinations of polymers with relatively high bond strength to acrylic and rubber adhesives and polymers with relative low bond strength to acrylic and rubber adhesives.

For this Example, the following films were used: an ionomer, Suryln 1652-1 available from DuPont of Wilmington, Del.; a polyethylene, Escorene LD 202 available from ExxonMobil Chemical of Houston, Tex.; a polypropylene, Escorene 3155 available from ExxonMobil Chemical of Houston, Tex.; a copolymer of polyethylene, Elvax 3200 available from DuPont of Wilmington, Del.; a polyester, Corterra 509201 available from Shell Chemical of Houston, Tex.; a copolymer of polyethylene, Soarnol BG 3522 available from Soarus of City, ST; and a nylon copolymer, Griltex 1330A available from EMS Chemie of City, ST. The results of the T-peel strength measurement can be found in Table V.

TABLE V

| | | Average Peel |
|---|---|---|
| Composite | Temperature (° F.) | Strength (N/25 mm) |
| Ionomer/LDPE | 225 | 13.3 |
| Ionomer/LDPE | 275 | >9.1(ii) |
| Ionomer/LDPE | 325 | >14.7(i) |
| PP/LDPE | 225 | 0.06(iii) |
| PP/LDPE | 275 | 0.34 |
| PP/LDPE | 325 | 1.22 |
| PTT/EVA | 225 | 0.04 |
| PTT/EVA | 275 | 0.25 |
| PTT/EVA | 325 | 0.23 |
| EVOH/EVA | 225 | 0.27 |
| EVOH/EVA | 275 | 0.30 |
| EVOH/EVA | 325 | 1.24 |
| Nylon Copolymer/EVA | 225 | 0.16 |
| Nylon Copolymer/EVA | 275 | 0.28 |
| Nylon Copolymer/EVA | 325 | 2.00 |

(i)One of the films broke before the composite was peeled apart.
(ii)One of the films elongated significantly before the composite was peeled apart.
(iii)One samole did not seal at all.

In summary, care must be taken when choosing polymers for the “face” and “back” of the tape base substrate to allow optimal bonding between the two polymers. It is important to note that one cannot randomly pick a polymer with high bond strength with the chosen adhesive and a polymer with low bond strength and expect the two to form a tape base composite that performs well.

In this Example, the preferred combination of “face” and “back” polymer is Escorene LD 202 and Surlyn 1652-1. The preferred combination resulted in a T-peel strength of 7 to 64 times better than the four other combinations. This will result in a better internal bond and a better performing tape base substrate.

### EXAMPLE 4

Example 4 illustrates the importance of processing conditions on composite tape base properties.

Twenty samples of a fabric/polymer composite containing of Surlyn 1652-1 (an ionomer available from DuPont of Wilmington, Del.) and Escorene LD 202 (a polyethylene available from ExxonMobil Chemical Co. of Houston, Tex.) extrusion coated onto an 18×14 weft-inserted warp-knit fabric (available from Milliken & Company of Spartanburg, S.C.) were produced using two 6 in. Egan Davis Standard extruders and two Cloeren internally deckled T-slot dies. The fabric contains polyester yarns in both the warp and weft directions. The yarn size in the warp direction is 50 denier and the yarn size in the weft direction is 150 denier. Both the ionomer and the low-density polyethylene contained SCC 16674 “New White” a white pigment at approximately 2% by weight. The white pigment is a color concentrate containing 48.5% Titanium Dioxide by weight in a low-density polyethylene carrier resin (available from Standridge Color Corp. of Social Circle, Ga.).

The samples were made on an Egan/Davis-Standard extrusion coating line at a line speed of 125 ft/min. The Egan/Davis-Standard coating line is a tandem line with the ability to coat both sides of a substrate in a single pass. In all cases the ionomer was coated onto the substrate first. The ionomer had solidified before the low-density polyethylene was applied to the other side of the substrate. The melt temperature of the ionomer, which will be referred to as the “back” polymer, was held constant at 580° F. (304° C.). The melt temperature of the low-density polyethylene, which will be referred to as the “face” polymer, was varied between 560° F. to 600° F. (293-316° C.). During the processing of the samples, the thickness of the two polymers was also varied. The thickness of the “back” polymer was varied between 1 mil (25 microns)-4 mils (100 microns) and the thickness of the “face” polymer was varied between 2 mils (50 microns)-4 mils (100 microns). Each sample consisted of approximately 20 yards of fabric coated on both sides as described above. A 1 in. by 6 in. (25 mm by 150 mm) piece of each sample was die cut and placed into an MTS Sintech 1/S tensile testing machine (available from MTS Systems Corp. of Research Triangle Park, N.C.) for testing.

The measurements for mean peel strength of a standard tape from the sample were performed by applying an unsupported acrylic adhesive (4972 LE, available from 3M Co. of St. Paul, Minn.) to a 48-gauge metallized polyester film with an optical density of 2.0. The unsupported adhesive was applied to the polyester film using the PSTC standard rubber covered steel roller. Downward force was applied to the roller to allow for intimate bonding between the adhesive and the polyester film. From these samples 1 in. by 6 in. (25 mm by 152 mm) pieces of the composite were die cut for peel strength measurements off of the twenty samples.

Each sample was prepared in the same manner as the polymer films were prepared for peel testing in Example 1. Once the sample had been applied to the steel plate, the polyester film/unsupported adhesive composite was applied to the sample in the same manner that the commercially available tape was applied to the polymer films in Example 1. The resulting data is a measurement of the force required to peel the polyester film/unsupported adhesive composite from each individual sample.

Table VI lists important measurements for a tape base substrate that can be affected by the processing conditions under which the tape base is produced.

TABLE IV

| | | | | | | | | | | Mean | | | | |
|---|---|---|---|---|---|---|---|---|---|---|---|---|---|---|
| | | | | | | | | | | Peel | | | | |
| | | | | | | | | | | Strength | | | | |
| | | | | | | | | | | Std. | | | | |
| | | | | | | | | | | Tape | | | | |
| | | | “Face” | | | | “Back” | | Avg. | From | MD | CD | | |
| | “Face” | “Back” | Melt | Fabric Pre | Ozone | Ozone | Post | Avg. | Basis | Sample | Stiff- | Stiff- | Fill | Warp |
| Sample | Thickness | Thickness | Temp | Corona | “Face” | “Back” | Corona | Caliper | Weight | (N/25 | ness | ness | Tear | Tear |
| Number | (microns) | (microns) | (° C.) | Treatment | Polymer | Polymer | Treatment | (microns) | (gsm) | mm) | (g) | (g) | (g) | (g) |
| 1 | 100 | 100 | 293 | on | off | off | on | 213.5 | 2.95 | 6.7 | 182.2 | 149 | 213.3 | 341.3 |
| 2 | 50 | 25 | 293 | on | on | on | on | 120.5 | 1.33 | 4.4 | 28.4 | 21 | 384 | 341.3 |
| 3 | 75 | 62.5 | 304 | off | off | off | off | 155.0 | 2.12 | 7.1 | 77 | 57.2 | 192 | 256 |
| 4 | 50 | 25 | 316 | off | on | on | off | 119.0 | 1.37 | 5.3 | 28.2 | 22.4 | 256 | 320 |
| 5 | 100 | 100 | 316 | off | off | off | off | 216.0 | 2.99 | 7.1 | 186.6 | 151 | 234.7 | 277.3 |
| 6 | 50 | 100 | 316 | off | on | off | on | 167.5 | 2.36 | 6.7 | 105.2 | 86.4 | 277.3 | 277.3 |
| 7 | 100 | 25 | 316 | off | off | on | on | 156.0 | 2.02 | 7.1 | 66.2 | 52.4 | 256 | 341.3 |
| 8 | 75 | 62.5 | 304 | off | off | off | on | 160.0 | 2.20 | 6.7 | 89.6 | 58.2 | 192 | 298.7 |
| 9 | 50 | 100 | 293 | on | on | off | off | 147.0 | 1.72 | 6.2 | 52.4 | 48.8 | 260.3 | 296.5 |
| 10 | 100 | 25 | 293 | on | off | on | off | 152.5 | 2.02 | 6.2 | 68.2 | 56.4 | 256 | 320 |
| 11 | 50 | 100 | 293 | off | off | on | on | 164.5 | 2.32 | 6.7 | 95.2 | 85.4 | 234.7 | 256 |
| 12 | 100 | 25 | 293 | off | on | off | on | 151.0 | 1.98 | 6.2 | 65.4 | 54.4 | 256 | 256 |
| 13 | 75 | 62.5 | 304 | off | on | off | off | 154.0 | 2.14 | 6.2 | 76.8 | 53.8 | 192 | 256 |
| 14 | 50 | 100 | 316 | on | off | on | off | 164.0 | 2.24 | 6.7 | 83.2 | 75.6 | 256 | 256 |
| 15 | 100 | 25 | 316 | on | on | off | off | 149.5 | 1.93 | 6.2 | 59.6 | 47.6 | 298.7 | 277.3 |
| 16 | 100 | 100 | 316 | on | on | on | on | 212.5 | 2.92 | 6.7 | 170.8 | 137.6 | 213.3 | 384 |
| 17 | 50 | 25 | 316 | on | off | off | on | 118.5 | 1.33 | 4.0 | 25 | 20 | 277.3 | 320 |
| 18 | 75 | 62.5 | 304 | off | on | off | on | 154.0 | 2.13 | 6.7 | 73 | 55 | 192 | 234.7 |
| 19 | 100 | 100 | 293 | off | on | on | off | 215.5 | 2.97 | 6.7 | 170.4 | 135 | 192 | 277.3 |
| 20 | 50 | 25 | 293 | off | off | off | off | 120.0 | 1.33 | 4.9 | 23.4 | 18.6 | 341.3 | 384 |

| | | | | | | | | | | | | | TEA | | |
|---|---|---|---|---|---|---|---|---|---|---|---|---|---|---|---|
| | “Face” | “Back” | | Fabric | | | | Tensile | Tensile | % | % | TEA, | Wa- | | |
| | Thick- | Thick- | “Face” | Pre | | | “Back” | @ | @ | Elong. | Elong. | Fill | rp, | Modu- | |
| | ness | ness | Melt | Corona | Ozone | Ozone | Post | Break, | Break, | @ | @ | (N- | (N- | lus | Modulu |
| Sample | (mic- | (mic- | Temp | Treat- | “Face” | “Back” | Corona | Fill | Warp | Break, | Break, | m/ | m/ | Fill | Warp |
| Number | rons) | rons) | (° C.) | ment | Polymer | Polymer | Treatment | (N) | (N) | Fill | Warp | cm2) | cm2) | (PSI) | (P |
| 1 | 100 | 100 | 293 | on | off | off | on | 144.6 | 125.0 | 26.4 | 28.5 | 91.1 | 99.5 | 267295 | 30730 |
| 2 | 50 | 25 | 293 | on | on | on | on | 0.0 | 0.0 | 26.5 | 28.4 | 66.6 | 75.0 | 294646 | 39778 |
| 3 | 75 | 62.5 | 304 | off | off | off | off | 0.0 | 0.0 | 22.8 | 28.3 | 4.9 | 82.6 | 304892 | 36987 |
| 4 | 50 | 25 | 316 | off | on | on | off | 0.0 | 0.0 | 25.7 | 27.7 | 5.6 | 64.5 | 299604 | 40119 |
| 5 | 100 | 100 | 316 | off | off | off | off | 0.0 | 0.0 | 25.7 | 28.6 | 82.6 | 101.6 | 266654 | 31714 |
| 6 | 50 | 100 | 316 | off | on | off | on | 0.0 | 0.0 | 24.3 | 27.5 | 71.4 | 88.3 | 314882 | 38540 |
| 7 | 100 | 25 | 316 | off | off | on | on | 0.0 | 0.0 | 21.9 | 26.6 | 52.5 | 73.5 | 311104 | 37877 |
| 8 | 75 | 62.5 | 304 | off | off | off | on | 0.0 | 0.0 | 25.1 | 25.7 | 72.1 | 721.4 | 315999 | 38621 |
| 9 | 50 | 100 | 293 | on | on | off | off | 0.0 | 0.0 | 25.3 | 26.5 | 62.3 | 70.8 | 278685 | 37697 |
| 10 | 100 | 25 | 293 | on | off | on | off | 0.0 | 0.0 | 27.7 | 29.2 | 81.3 | 86.2 | 291192 | 37205 |
| 11 | 50 | 100 | 293 | off | off | on | on | 0.0 | 0.0 | 22.2 | 27.5 | 60.2 | 84.8 | 310256 | 37461 |
| 12 | 100 | 25 | 293 | off | on | off | on | 0.0 | 0.0 | 26.0 | 27.7 | 67.9 | 74.2 | 279954 | 36346 |
| 13 | 75 | 62.5 | 304 | off | on | off | off | 0.0 | 0.0 | 24.9 | 28.8 | 70.0 | 83.4 | 310842 | 36919 |
| 14 | 50 | 100 | 316 | on | off | on | off | 0.0 | 0.0 | 27.1 | 28.6 | 83.4 | 90.4 | 304175 | 36766 |
| 15 | 100 | 25 | 316 | on | on | off | off | 0.0 | 0.0 | 25.1 | 27.3 | 67.2 | 75.7 | 289737 | 36724 |
| 16 | 100 | 100 | 316 | on | on | on | on | 0.0 | 0.0 | 24.2 | 25.0 | 78.4 | 82.6 | 274865 | 32140 |
| 17 | 50 | 25 | 316 | on | off | off | on | 0.0 | 0.0 | 21.4 | 25.5 | 40.6 | 60.2 | 318288 | 42515 |
| 18 | 75 | 62.5 | 304 | off | on | off | on | 0.0 | 0.0 | 21.5 | 28.6 | 53.2 | 86.2 | 310353 | 37571 |
| 19 | 100 | 100 | 293 | off | on | on | off | 0.0 | 0.0 | 25.6 | 28.0 | 89.0 | 98.1 | 270735 | 31162 |
| 20 | 50 | 25 | 293 | off | off | off | off | 0.0 | 0.0 | 24.1 | 26.7 | 54.6 | 64.5 | 293516 | 40026 |

Trends show that as the thickness of the “face” and “back” polymer increases, the peel strength of the standard tape to the sample increases. The effect due to the thickness of the “back” polymer is greater than the effect due to the thickness of the “face” polymer. Also, the unwind peel adhesion is greater when the fabric pre-corona treatment is turned off.

It is also important to note the contribution to stiffness in the machine and cross machine direction of the processing conditions of the tape base substrate. Conformability of the tape base substrate is often important in adhesive tape applications where the tape must be applied to non-uniform surfaces. In this example, the trends show that as the coating thickness of the “face” or “back” polymer increases, the stiffness of the overall composite increases as well in both the machine and cross machine direction.

Tape behaviors can be optimized by processing the tape substrate under certain parameters. In this case, controlling the thicknesses of the two polymer layers can maximize the adhesion of the adhesive tape to both a standard steel plate and “face” polymer of the tape composite. It is also important to note the contribution to stiffness in the machine and cross machine direction of the processing conditions of the tape base substrate.

### EXAMPLE 5

Example 5 illustrates the importance of processing conditions on composite adhesive tape performance.

Measurements of peel strength off of a standard steel plate of an adhesive tape produced from each of the twenty samples documented in Example 4 were performed to show the relationship between adhesive tape performance and processing conditions used to produce the backing used to make said adhesive tape.

First, a commercially available unsupported acrylic adhesive (4792 LE, from 3M Co. of St. Paul, Minn.) was applied to each of the twenty samples using the standard rubber covered roller documented in Example 1. Care must be taken during application of the adhesive to ensure that no air bubbles are formed between the adhesive and the tape base. Downward force was used to apply the adhesive to the tape base to ensure intimate bonding between the adhesive and the tape base. Once adhesive had been applied to all of the twenty samples, the adhesive coated samples were allowed to condition in PSTC standard conditions (23+/−2° C. and Relative Humidity of 50+/−2%) for 24 hours.

After 24 hours the samples were die cut into 1 in. by 6 in. (25 mm by 152 mm) pieces for peel strength to steel plate measurements. The standard steel plates (see ASTM D 3330-96) were cleaned with a solvent using PSTC standard cleaning procedures before testing was performed. After cleaning, the plates were allowed to dry for ten minutes. Once the steel plates had dried, the sample to be evaluated was applied to the steel plate using the standard rubber covered roller. The samples were applied in the same manner as described in Example 1 for application of commercially available adhesive tapes to polymer film for peel strength testing.

The samples were prepared for insertion into the tensile tester in the same manner as described in Example 1. The same tensile testing machine was used to perform the measurements. The results of the measurements can be seen in Table VII.

TABLE VII

| | Avg. Peel |
|---|---|
| Sample | Load |
| Number | (N/25 mm) |
| 1 | 14.2 |
| 2 | 13.3 |
| 3 | 15.1 |
| 4 | 12.0 |
| 5 | 13.8 |
| 6 | 11.6 |
| 7 | 12.5 |
| 8 | 12.0 |
| 9 | 13.8 |
| 10 | 9.8 |
| 11 | 13.3 |
| 12 | 12.0 |
| 13 | 14.2 |
| 14 | 12.0 |
| 15 | 12.9 |
| 16 | 13.8 |
| 17 | 12.9 |
| 18 | 12.9 |
| 19 | 15.1 |
| 20 | 12.5 |

Processing conditions of the tape base can have an effect on the performance of the adhesive tape composite. The trends show that as the thickness of the “face” or “back” polymer increases the peel strength of the composite off of steel increases. The effect due to the “back” polymer thickness is greater than the effect due to the “face” polymer. Also, as the melt temperature of the “face” polymer increases the peel strength decreases. Therefore, it is important to consider the effect the tape base processing conditions might have on the overall performance of the adhesive tape composite.

### EXAMPLE 6

Example 6 illustrates that unbalanced structures, which reduce the curl of the total composite, are useful in the present invention.

Measurements of curl in both the machine direction and the cross machine direction were performed on each of the series of twenty samples documented in Example 4 above to determine what effects the process variables had on the performance of the composite samples. Curl in the machine direction is defined herein as the machine direction fibers curling upwards and curl in the cross machine direction will be defined as the cross machine direction fibers curling upwards. An 8 in. (203.2 mm) by 11 in. (279.4 mm) piece of each of the twenty samples was die cut and placed on a large table and allowed to sit undisturbed for approximately one hour. After one hour, the samples were measured for total length in both directions using a standard ruler. Due to the method used, a larger number indicates less curl in either direction. In all cases the composite curled towards the side coated with polyethylene. Table VIII shows the results of the curl measurements.

TABLE VIII

| | “Face” | “Back” | “Back” Melt | MD | CD |
|---|---|---|---|---|---|
| Sample | Thickness | Thickness | Temperature | Curl | Curl |
| Number | (microns) | (microns) | (° C.) | (mm) | (mm) |
| 1 | 100 | 100 | 293 | 257.18 | 201.61 |
| 2 | 50 | 25 | 293 | 277.81 | 203.20 |
| 3 | 75 | 62.5 | 304 | 271.46 | 200.03 |
| 4 | 50 | 25 | 316 | 277.81 | 203.20 |
| 5 | 100 | 100 | 316 | 266.70 | 203.20 |
| 6 | 50 | 100 | 316 | 277.81 | 203.20 |
| 7 | 100 | 25 | 316 | 277.81 | 128.59 |
| 8 | 75 | 62.5 | 304 | 277.81 | 200.03 |
| 9 | 50 | 100 | 293 | 273.05 | 203.20 |
| 10 | 100 | 25 | 293 | 279.40 | 0.00 |
| 11 | 50 | 100 | 293 | 269.88 | 203.20 |
| 12 | 100 | 25 | 293 | 279.40 | 0.00 |
| 13 | 75 | 62.5 | 304 | 273.05 | 201.61 |
| 14 | 50 | 100 | 316 | 276.23 | 203.20 |
| 15 | 100 | 25 | 316 | 277.80 | 139.70 |
| 16 | 100 | 100 | 316 | 273.05 | 201.61 |
| 17 | 50 | 25 | 316 | 276.10 | 203.20 |
| 18 | 75 | 62.5 | 304 | 271.46 | 201.61 |
| 19 | 100 | 100 | 293 | 265.11 | 203.20 |
| 20 | 50 | 25 | 293 | 279.40 | 203.20 |

In summary, trends show that as the coating thickness of either the “face” or “back” polymer is increased, the curling in the cross machine direction increases. The effect due to the “back” polymer is relatively greater than the effect due to the “face” polymer. However, the trends show that as the melt temperature of the “face” coating is increased the curling in the cross machine direction decreases.

In the machine direction the trends show that as the coating thickness of the “face” coating is increased the curling increases, but as you increase the “back” coating the curling decreases. Again, the trends show that as the “face” melt temperature is increased the curling decreases.

It is preferred to have a tape substrate that does not curl to facilitate application of an adhesive thereto, and also to facilitate use. By varying the coating weights of the “face” and “back” coating, a substrate with little or no curl can be produced even if the two polymers used to make the composite are dissimilar.

### EXAMPLE 6

Example 6 illustrates that order of addition of the two polymers of the total composite, is important in the present invention.

As mentioned earlier, the process used to create the composite plays an important role in the behavior of the tape base and the performance of the adhesive tape made from the said tape base. In the present invention the tape base substrate can be made using a tandem extrusion coating system that applies polymer coatings on either side of a substrate in a single pass. Also, the polymer that is applied via the first extruder has enough time to solidify before the second polymer is applied to the opposite side of the fabric.

The fabric mentioned in Example 4 above itself is open in nature, meaning that the interstices of the fabric are large. This openness allows the first polymer to flow through the substrate and create a relatively flat layer for the second polymer to be applied onto. This flat coating surface allows for a much smoother surface of the opposite side of the second polymer. By applying the backside polymer first to the scrim, the formation of unsightly dimples is minimized on the face side. The dimples are caused by air entrapment during face coating due to the three-dimensional nature of the fabric scrim. Dimples in the face side are unacceptable aesthetic qualities in certain applications such as gaffer's tape, where the smooth curved surface of the dimples appears as shiny spots against the matte black background of the rest of the surface.

It is important to note that the dimples can be minimized by adjusting process conditions as well. The nineteen samples from Example were evaluated for dimples/unit area. Nineteen samples of a fabric/polymer composite comprised Escorene LD 202 (a polyethylene available from ExxonMobil Chemical Co. of Houston, Tex.) extrusion coated on either side of an 18×14 weft-inserted warp-knit fabric (available from Milliken & Company of Spartanburg, S.C.) were produced using the same process as described in Example 4. One coating of the low-density polyethylene contained SCC 27830 a black pigment at approximately 2% by weight. The white pigment is a color concentrate containing 40% Carbon Black by weight in a linear low-density polyethylene carrier resin (available from Standridge Color Corp. of Social Circle, Ga.). The samples were processed at a line speed of 125 ft/min. The melt temperature of the “back” polymer, was held constant at 580° F. (304° C.). The melt temperature of the “face” polymer, was varied between 525° F. to 600° F. (274-316° C.). During the processing of the samples, the thickness of the two polymers was also varied. The thickness of the “back” polymer was varied between 0.75 mil (18.75 microns)-2.75 mils (68.75 microns) and the thickness of the “face” polymer was varied between 1 mils (25 microns)-5 mils (125 microns). Each sample consisted of approximately 20 yards of fabric coated on both sides as described above.

Samples for evaluation were made by die cutting an 8 in. by 11 in. (203 mm by 279 mm) piece of each sample and placing the sample under a light microscope. Using the microscope, a standard area of the surface of the sample was enlarged (250×) and the number of dimples per unit area was counted. The average of the number of dimples per unit area was taken for each sample and compared to the relative amount of dimples. Table IX shows the dimple/unit area measurements for the nineteen samples.

TABLE IX

| | | “Face” Coat | “Back” Coat | |
|---|---|---|---|---|
| Sample | “Face” Melt | Thickness | Thickness | Average |
| Number | Temp. (° C.) | (microns) | (microns) | Dimples/Area |
| 1 | 295.5 | 75 | 43.75 | 0.2 |
| 2 | 274 | 25 | 18.75 | 34.4 |
| 3 | 274 | 25 | 68.75 | 34.6 |
| 4 | 274 | 75 | 43.75 | 0.4 |
| 5 | 274 | 125 | 18.75 | 2.4 |
| 6 | 274 | 125 | 68.75 | 0.0 |
| 7 | 295.5 | 75 | 43.75 | 1.1 |
| 8 | 295.5 | 25 | 43.75 | 34.7 |
| 9 | 295.5 | 75 | 18.75 | 8.7 |
| 10 | 295.5 | 75 | 43.75 | 0.3 |
| 11 | 295.5 | 75 | 68.75 | 0.5 |
| 12 | 295.5 | 125 | 43.75 | 0.1 |
| 13 | 295.5 | 75 | 43.75 | (i) |
| 14 | 316 | 25 | 18.75 | 36.9 |
| 15 | 316 | 25 | 68.75 | 35.5 |
| 16 | 316 | 75 | 43.75 | 0.7 |
| 17 | 316 | 125 | 18.75 | 10.7 |
| 18 | 316 | 125 | 68.75 | 0.0 |
| 19 | 295.5 | 75 | 43.75 | 0.4 |

(i)Not Determined.

The trends show that as the melt temperature of the face polymer increases the number of dimples/unit area increases. Also, as the “face” polymer thickness increases the number of dimples decreases.

While the invention has been described and disclosed in connection with certain preferred embodiments and procedures, these have by no means been intended to limit the invention to such specific embodiments and procedures. Rather, the invention is intended to cover all such alternative embodiments, procedures, and modifications thereto as may fall within the true spirit and scope of the invention as defined and limited only by the appended claims.

What is claimed is:

1. A composite tape substrate comprising:
a first polymeric layer on a face side thereof, said first polymeric layer being chosen from the group consisting of: silicone grafted polyethylene, poly tetrafluoroethylene, fluoronated polyolefins, chloronated polyolefins, polyethylene (including low density, high density, linear low density, medium density, and metallocene catalyzed), polypropylene, EPDM rubber, polyvinyl stearyl carbamate, poly chloro trifluoroetylene, polystyrene, polyvinyl chloride, and any combinations thereof;
a second polymeric layer forming a backside of said composite tape substrate, said second polymeric layer being chosen from the group consisting of: nylon (including nylon 6, nylon 6,6, nylon 11, nylon 2, nylon 12), polyurethane (aliphatic: polyether or polyester, aromatic: polyether or polyester), polyvinylidene chloride, polyethylene terephthalate and copolymers of the same, polybutylene terephthalate and copolymers of the same, poly trimethylene terephthalate and copolymers of the same, copolymers of polyethylene (including ionomers, ethylene acrylic acid, ethylene methyl acrylate, ethylene vinyl acetate, ethylene n-butyl acrylate), polyacrylonitrile, polymethylmethacrylate, polycarbonate, polysulfone, cellophane, and any combinations thereof.

2. The composite tape substrate set forth in claim 1, further including an adhesive applied to said second polymeric layer.

3. The composite tape substrate set forth in claim 2, wherein said adhesive is selected from the group consisting of: rubber based adhesives (both natural and synthetic), acrylic based adhesives, silicone based adhesives, polyurethane based adhesives, and any combination thereof.

4. The composite tape substrate set forth in claim 2, wherein said adhesive is selected from the group consisting of: Natural Rubber, Polyisoprene, Styrene-Isoprene Block Copolymer, Styrene-Butadiene Block Copolymer, Butyl Rubber, Polystyrene-Poly(ethylene/butylene)-Polystyrene, Polystyrene-Poly(ethylene/propylene)-Polystyrene, Polystyrene-Polyisoprene-Polybutadiene, Polybutene, Polyacrylates, Polydiacrylates, Polytriacrylates, Polymethacrylates, Polydimethacrylates, Polytrimethacrylates, Polytetramethacrylates, Polyacrylamides, Polymethacrylamides, Polyacrylimides, Polymethacrylimides, Polymethacrylic acid, Polyacrolein, Polymethacrylonitrile, Poly(maleic acid) and derivatives, Poly(fumaric acid) and derivatives, Poly(crotonic acid) and derivatives, Poly(itaconic acid) and derivatives, Poly(ciraconic acid) and derivatives, Poly(maleamic acid) and derivatives, Poly(vinyl ethers), Polyisocyanates, Polystyrene and derivatives, Polylactones, Polybetaines.

5. The composite tape substrate set forth in claim 1, further including a textile fabric disposed between said first and second polymeric layers.

6. The composite tape substrate set forth in claim 4, wherein said textile fabric is a weft inserted warp knit fabric.

7. The composite tape substrate set forth in claim 1, wherein said first polymeric layer comprises polyethylene and said second polymeric layer comprises ionomer.

8. The composite tape substrate set forth in claim 7, further including an adhesive applied to said second polymeric layer, wherein said adhesive is chosen from the group consisting of: Polyacrylates, Polydiacrylates, Polytriacrylates, Polymethacrylates, Polydimethacrylates, Polytrimethacrylates, Polytetramethacrylates, Polyacrylamides, Polymethacrylamides, Polyacrylimides, Polymethacrylimides, Polymethacrylic acid, Polyacrolein, Polymethacrylonitrile, Poly(maleic acid) and derivatives, Poly(fumaric acid) and derivatives, Poly(crotonic acid) and derivatives, Poly(itaconic acid) and derivatives, Poly(ciraconic acid) and derivatives, Poly(maleamic acid) and derivatives, Poly(vinyl ethers), Polyisocyanates, Polystyrene and derivatives, Polylactones, Polybetaines.

9. The composite tape substrate set forth in claim 1, wherein said first polymeric layer comprises ethylene propylene copolymer and said second polymeric layer comprises polypropylene.

10. The composite tape substrate set forth in claim 9, further including an adhesive applied to said second polymeric layer, wherein said adhesive is chosen from the group consisting of: Natural Rubber, Polyisoprene, Styrene-Isoprene Block Copolymer, Styrene-Butadiene Block Copolymer, Butyl Rubber, Polystyrene-Poly(ethylene/butylene)-Polystyrene, Polystyrene-Poly(ethylene/propylene)-Polystyrene, Polystyrene-Polyisoprene-Polybutadiene, Polybutene.

11. A composite tape substrate comprising:
a first polymeric layer having a contact angle of greater than about 100° as tested by using distilled water as the standard fluid; and
a second polymeric layer attached to said first polymeric layer, said second polymeric layer having a contact angle of less than said contact angle of said first polymeric layer as tested by using distilled water as the standard fluid.

12. The composite tape substrate set forth in claim 11, further including a textile fabric encapsulated between said first and second polymeric layers.

13. The composite tape substrate set forth in claim 12, wherein said textile fabric is a weft inserted warp knit fabric.

14. A process for manufacturing a composite tape substrate, said process comprising the steps of:
providing a first polymeric layer having a contact angle of greater than about 100° as tested by using distilled water as the standard fluid;
attaching a second polymeric layer to said first polymeric layer, said second polymeric layer having a contact angle of less than said contact angle of said first polymeric layer as tested by using distilled water as the standard fluid.

15. The process set forth in claim 14, further including the step of encapsulating a textile fabric layer between said first and second polymeric layers.

16. The process set forth in claim 15, wherein said textile fabric layer is a weft inserted warp knit fabric.

17. The process set forth in claim 14, wherein said first polymeric layer is selected from the group consisting of: nylon (including nylon 6, nylon 6,6, nylon 11, nylon 2, nylon 12), polyurethane (aliphatic: polyether or polyester, aromatic: polyether or polyester), polyvinylidene chloride, polyethylene terephthalate and copolymers of the same, polybutylene terephthalate and copolymers of the same, poly trimethylene terephthalate and copolymers of the same, copolymers of polyethylene (including ionomers, ethylene acrylic acid, ethylene methyl acrylate, ethylene vinyl acetate, ethylene n-butyl acrylate), polyacrylonitrile, polymethylmethacrylate, polycarbonate, polysulfone, cellophane, and any combinations thereof.

18. The process set forth in claim 14, wherein said second polymeric layer is selected from the group consisting of: silicone grafted polyethylene, poly tetrafluoroethylene, fluoronated polyolefins, chloronated polyolefins, polyethylene (including low density, high density, linear low density, medium density, and metallocene catalyzed), polypropylene, EPDM rubber, polyvinyl stearyl carbamate, poly chloro trifluoroetylene, polystyrene, polyvinyl chloride, and any combinations thereof.

19. The process set forth in claim 14, wherein said adhesive is selected from the group consisting of: rubber based adhesives (both natural and synthetic), acrylic based adhesives, silicone based adhesives, polyurethane based adhesives, and any combination thereof.

20. A process for manufacturing a composite tape, said process comprising the steps of:
providing a textile fabric having two sides;
applying a backside polymer layer to one side of said textile fabric;
applying a face side polymer to the other side of said textile fabric after said backside polymer layer has been applied to said textile fabric; and
applying adhesive to said backside layer.

21. The process set forth in claim 20, wherein said backside polymer layer exhibits a contact angle of greater than about 100° as tested by using distilled water as the standard fluid.

22. The process set forth in claim 20, wherein said face side polymer layer exhibits a contact angle of less than about 100° as tested by using distilled water as the standard fluid.

23. The process set forth in claim 20, wherein said textile fabric is a weft inserted warp knit fabric.

24. The process set forth in claim 20, wherein said face side polymer layer is selected from the group consisting of: silicone grafted polyethylene, poly tetrafluoroethylene, fluoronated polyolefins, chloronated polyolefins, polyethylene (including low density, high density, linear low density, medium density, and metallocene catalyzed), polypropylene, EPDM rubber, polyvinyl stearyl carbamate, poly chloro trifluoroetylene, polystyrene, polyvinyl chloride, and any combinations thereof.

25. The process set forth in claim 20, wherein said backside polymer layer is selected from the group consisting of: nylon (including nylon 6, nylon 6,6, nylon 11, nylon 2, nylon 12), polyurethane (aliphatic: polyether or polyester, aromatic: polyether or polyester), polyvinylidene chloride, polyethylene terephthalate and copolymers of the same, polybutylene terephthalate and copolymers of the same, poly trimethylene terephthalate and copolymers of the same, copolymers of polyethylene (including ionomers, ethylene acrylic acid, ethylene methyl acrylate, ethylene vinyl acetate, ethylene n-butyl acrylate), polyacrylonitrile, polymethylmethacrylate, polycarbonate, polysulfone, cellophane, and any combinations thereof.

26. The process set forth in claim 20, wherein the addition of said face and backside polymers to said textile fabric is performed using either hot calendaring, hot melt, or extrusion coating.

27. The process set forth in claim 20, wherein said adhesive is applied from solution, dispersion, hot melt, is hot calendared, extrusion coated, or is calendared.

28. A composite tape substrate comprising:
a first polymeric layer having a first contact angle as tested by using distilled water as the standard fluid; and
a second polymeric layer attached to said first polymeric layer, said second polymeric layer having a second contact angle, said second contact angle being less than said first contact angle as tested by using distilled water as the standard fluid.

29. The composite tape substrate set forth in claim 28, further including a textile fabric encapsulated between said first and second polymeric layers.

30. The composite tape substrate set forth in claim 29, wherein said textile fabric is a weft inserted warp knit fabric.

31. The composite tape substrate set forth in claim 28, wherein said first contact angle is greater than 95°.

32. The composite tape substrate set forth in claim 28, wherein said composite has a curl of less than ⅛ in. per 8 in. in the cross machine direction and less than 3/16 in. curl per 11 in. in the machine direction.
